(19) United States
(12) Patent Application Publication
(10) Pub. No.: US 2026/0339918 A1
(43) Pub. Date: Oct. 29, 2026

(54) SECURE NETWORK ACTIVITY IN DISTRIBUTED COMPUTING ENVIRONMENT

(71) Applicant: ADP, Inc., Roseland, NJ (US)

(72) Inventor: Jyotsna MANIKANTAN, Edison, NJ (US)

(73) Assignee: ADP, Inc., Roseland, NJ (US)

(21) Appl. No.: 19/192,981

(22) Filed: Apr. 29, 2025

(51) Int. Cl. G06F 16/23; H04L 9/40

(52) U.S. Cl. CPC G06F 16/235; H04L 63/1425

(57) ABSTRACT

A system can receive an indication of a request to update a data record associated with a profile data structure. The request can include identification parameters to identify the data record to be updated and update parameters specifying the update to be applied to the data record. The system can filter, based on the identification parameters and the profile data structure, a plurality of databases maintained in a computing environment to identify a target database storing the data record to be updated. The system can determine, by inputting a subset of features associated with the data record into a machine learning model, that the request is indicative of an instance of fraud or a valid update request. The system can generate, upon determining that the request is indicative of the valid update request, instructions to cause the target database to update the data record based on the update parameters.

### TECHNICAL FIELD

This application is generally related to distributed cloud computing systems and, particularly, to providing secure network activity in a distributed computing environment.

### BACKGROUND

Distributed cloud computing systems can integrate multiple components to process and manage data record updates across interconnected environments. As these systems grow in scale, the volume of distributed data increases, leading to the coordination of data updates across various components. Managing data updates in such distributed environments includes configuring and synchronizing records across distributed nodes. This complexity introduces risks of errors, delays, or inefficiencies in the overall system performance.

### SUMMARY

Aspects of the technical solutions described herein address the challenges of providing secure network activity in a distributed computing environment, including with regard to managing data updates within the distributed computing environment. Propagating data modifications and maintaining data integrity across geographically distributed and independently managed computing nodes introduces multiple technical challenges. For example, the absence of system-wide integration mechanisms results in isolated systems of records and fragmented data silos, which hinder real-time or near real-time consistency across distributed data sources. Synchronization frameworks, particularly in geographically distributed environments, may cause eventual consistency violations (e.g., differences in data across nodes before all updates propagate), including stale reads, conflicting writes, and race conditions that impact data reliability. Referential integrity constraints across decentralized databases may become inconsistent due to out-of-order update propagation or asynchronous replication delays, leading to orphaned records or mismatched entity relationships. Interoperability constraints further impede data exchange across heterogeneous cloud services, database platforms, and application programming interface (API) endpoints, where variations in data serialization formats, schema evolution, and versioning introduce compatibility challenges. Inconsistent identity and access management (IAM) implementations impact authorization workflows, where multi-tenant access policies are not uniformly enforced across distributed environments. Additionally, the absence of distributed coordination protocols contributes to inconsistent data states across nodes, particularly in multi-region deployments with high network latency.

Furthermore, information linking and verification within the context of data updates introduce additional complexities in distributed data management. Real-time propagation of data modifications and continuous data lineage monitoring impose computational overhead, particularly when synchronizing updates across distributed environments with independently managed components. Data validation includes differentiating between high-priority and low-priority updates, where static validation rules may not account for evolving data distributions, while dynamic validation methods can introduce variability that affects consistency across systems. Additionally, asynchronous update propagation and incomplete audit trails hinder the detection of microfraud patterns across disparate systems. Regulatory and operational constraints can further influence data consistency and governance, particularly in environments lacking a centralized database. As a result, inconsistencies in data propagation, tracking, and access control policies within distributed computing environments can contribute to unauthorized modifications or discrepancies in datasets managed within the distributed computing environment.

The technical solutions described herein address these and other technical challenges by implementing a distributed data management framework for providing secure network activity in a distributed computing environment, including with regard to managing data updates within the distributed computing environment. The framework incorporates a microservice-based architecture, including a series of independently deployable microservices, each configured to perform specific functions such as request processing, database filtering, feature selection, and fraud detection before applying updates to distributed data sources. Upon receiving an update request, the system parses the request parameters to extract identification parameters that reference the requested data record and update parameters specifying modifications. The system queries distributed data sources to identify the target database maintaining the requested data record and retrieves relevant metadata, such as schema information, data ownership details, or access control lists, associated with the requested update. A feature extraction component, using predefined rules or learned models, selects a subset of features from the data record that are pertinent to fraud detection, incorporating contextual indicators such as historical modification patterns, frequency of changes, and cross-referenced entity relationships. The technical solutions implement a machine learning model trained on labeled datasets of prior update requests to classify whether the incoming request is indicative of fraudulent activity or a valid modification. The fraud detection model may evaluate anomaly scores, deviation from historical trends, and correlations between modification events across multiple sources to infer potential risks. To maintain data integrity and synchronization, the technical solutions implement a dynamic schema mapping and change detection service that, using a distributed graph database, tracks relationships between data elements across interconnected microservices and distributed databases. Additionally, batch processing pipelines periodically evaluate captured data snapshots to track state transitions and applied updates, recording detailed metadata such as IP addresses, timestamps, and event origin details to maintain an audit trail and support data integrity verification. The audit trails provide forensic records for anomaly detection, compliance reporting, and fraud investigation. Upon determining that an update request is valid, the system generates execution instructions for the target database to apply modifications while maintaining data consistency, provenance tracking, and access controls across distributed systems.

The technical solutions described herein can further extend the distributed data management framework by incorporating API integrations to link profile data structures across heterogeneous databases, thereby facilitating efficient synchronization while preserving schema integrity across federated data sources. The system architecture dynamically adjusts linkage operation frequency based on performance metrics, such as data latency or system load. Baseline indexing mechanisms and scheduled batch processing pipelines support the initial alignment of data structures and maintain uniform representations of entity relationships across distributed environments. Moreover, a fraud verification interface allows authorized users to flag specific modifications for further analysis. The interface complements machine learning-driven fraud detection, allowing stakeholder intervention when automated anomaly detection is inconclusive. Additionally, asynchronous update propagation enhances system responsiveness by efficiently distributing data modifications across interdependent services. The audit logging system records provenance metadata, including the source system identifier, transaction lineage, and user interaction history, allowing for granular traceability for compliance reporting and fraud investigations. The technical solutions described herein provide a scalable and robust framework for managing data record updates and providing secure network activity in distributed computing environments.

An aspect of the technical solutions described herein is directed to a system. The system includes one or more processors coupled with memory. The system can receive an indication of a request to update a data record associated with a profile data structure. The request can include one or more identification parameters to identify the data record to be updated and one or more update parameters specifying the update to be applied to the data record. The system can filter, based on the one or more identification parameters and the profile data structure, a plurality of databases maintained in a computing environment to identify a target database storing the data record to be updated. The system can determine, by inputting a subset of features associated with the data record into a machine learning model, that the request is indicative of at least one of an instance of fraud or a valid update request. The system can generate, upon determining that the request is indicative of a valid update request, instructions to cause the target database to update the data record based on the one or more update parameters.

The system can receive the indication of the request to update the data record associated with the profile data structure in response to an event. The event can include at least one of a data modification event within the plurality of databases, a data generation event within the plurality of databases, a data synchronization event between the plurality of databases and an external system, or a scheduled data processing event. The one or more identification parameters can include at least one of an identifier associated with the data record, a timestamp associated with the data record, a location associated with the data record, an entity type associated with the data record, or a transaction type associated with the data record. The one or more update parameters can specify at least one of a modification of a value associated with a field within the data record, an addition of a new field to the data record, a deletion of an existing field from the data record, or a modification of a relationship between the data record and a second data record.

The system can maintain a mapping data structure associating the one or more identification parameters and the profile data structure with locations of data records in the plurality of databases maintained in the computing environment. The system can query the mapping data structure, based on the one or more identification parameters, to identify the target database storing the data record to be updated. Each database of the plurality of databases can store one or more data records associated with the profile data structure. Each data record can include a plurality of field-value pairs. The system can interact with an application programming interface (API) to coordinate data exchange between the plurality of databases maintained in the computing environment. The system can train the machine learning model on a training dataset, including a plurality of data records and corresponding labels, where the machine learning model can learn to associate features extracted from each data record with a label indicating whether the data record is fraudulent or valid.

Upon receipt of a second request to update a second data record, the system can determine, by inputting a second subset of features associated with the second data record into the machine learning model, a score that indicates a likelihood that the second request is fraudulent. The system can determine, based on a comparison of the score with a threshold, that the second request corresponds to the instance of fraud. The system can generate, responsive to the determination, a notification indicating that the second request corresponds to the instance of fraud. The system can generate instructions, upon determining that the request is indicative of the instance of fraud, to block the update request from being transmitted to the target database. The system can select the subset of features based on at least one of predefined rules for fraud detection or one or more machine learning models trained to identify features indicative of the instance of fraud.

An aspect of the technical solutions described herein is directed to a method. The method can include receiving, by a first system, a request to update a data record associated with a profile data structure. The request can include one or more identification parameters to identify the data record to be updated and one or more update parameters specifying the update to be applied to the data record. The method can include transmitting, by the first system, the request to a second system for validation. The method can include receiving, by the first system, a validation result from the second system. The validation result can indicate that the request is indicative of at least one of an instance of fraud or a valid update request. The method can include generating, by the first system, upon receiving the validation result indicating the valid update request, instructions to cause a target database of a plurality of databases maintained in a computing environment to update the data record based on the one or more update parameters.

The method can include receiving, by the first system, the request to update the data record associated with the profile data structure in response to an event. The event can include at least one of a data modification event within the plurality of databases, a data generation event within the plurality of databases, a data synchronization event between the plurality of databases and an external system, or a scheduled data processing event. The one or more identification parameters can include at least one of an identifier associated with the data record, a timestamp associated with the data record, a location associated with the data record, an entity type associated with the data record, or a transaction type associated with the data record. The one or more update parameters can specify at least one of a modification of a value associated with a field within the data record, an addition of a new field to the data record, a deletion of an existing field from the data record, or a modification of a relationship between the data record and a second data record. The method can include maintaining, by the first system, a mapping data structure associating the one or more identification parameters and the profile data structure with locations of data records in the plurality of databases maintained in the computing environment. The method can include querying, by the first system, the mapping data structure, based on the one or more identification parameters, to identify the target database storing the data record to be updated. Each database of the plurality of databases can store one or more data records associated with the profile data structure. Each data record can include a plurality of field-value pairs.

An aspect of this disclosure can be directed to a non-transitory computer readable medium, including one or more instructions stored thereon and executable by a processor. The processor can receive, from a first system, a request to update a data record associated with a profile data structure. The request can include one or more identification parameters to identify the data record to be updated and one or more update parameters specifying the update to be applied to the data record. The processor can determine, by inputting a subset of features associated with the data record into a machine learning model, that the request is indicative of at least one of an instance of fraud or a valid update request. The processor can transmit a validation result to the first system. The validation result can indicate that the request is indicative of the instance of fraud or the valid update request.

### BRIEF DESCRIPTION OF THE DRAWINGS

These and other aspects and features of the present implementations are depicted by way of example in the figures discussed herein. Present implementations can be directed to, but are not limited to, examples depicted in the figures discussed herein. Thus, this disclosure is not limited to any figure or portion thereof depicted or referenced herein, or any aspect described herein with respect to any figures depicted or referenced herein.

FIG. 1 depicts an example system, in accordance with some implementations.

FIG. 2 depicts an example process for providing secure network activity within a multidimensional node schema, in accordance with some implementations.

FIG. 3 depicts an example method of providing secure network activity in a distributed computing environment, in accordance with some implementations.

FIG. 4 depicts a block diagram of an example computing system for implementing the embodiments of the present solution, including, for example, the system depicted in FIG. 1, the process depicted in FIG. 2, and the method depicted in FIG. 3.

### DETAILED DESCRIPTION

Aspects of the technical solutions are described herein with reference to the figures, which are illustrative examples of this technical solution. The figures and examples below are not meant to limit the scope of the technical solutions to the present implementations or to a single implementation. Several other implementations in accordance with present implementations are possible, for example, by way of interchange of some or all of the described or illustrated elements. Where certain elements of the present implementations can be partially or fully implemented using known components, only those portions of such known components that are necessary for an understanding of the present implementations are described, and detailed descriptions of other portions of such known components are omitted to not obscure the present implementations. Terms in the specification and claims are to be ascribed no uncommon or special meaning unless explicitly set forth herein. Further, the technical solutions and the present implementations encompass present and future known equivalents to the known components referred to herein by way of description, illustration, or example.

The technical solutions described herein provide a multi-stage processing framework for managing data record updates and secure network activity in a distributed computing environment. A computing environment can include the integrated set of hardware, software, firmware, network resources, and services that can be used to perform computational tasks, manage data, and facilitate user interaction with computer systems, among others. The system receives an update request associated with a profile data structure, where the request includes identification parameters to identify the target data record and update parameters specifying the modifications. The system filters across multiple cloud-hosted databases using the identification parameters and profile data structure to determine the target database maintaining the data record to be updated. To determine the validity of the update request, the system selects a subset of features from an initial feature set associated with the data record, where the selection is based on fraud indicators. The system evaluates fraud risk at multiple levels by evaluating the request in a multidimensional feature space, where the feature vectors can encode attributes such as transaction history, request origin, temporal patterns, and benefit-specific characteristics, among others. A machine learning model, trained on a historical dataset including features extracted from multiple data records, evaluates the associated features to determine whether the update request is indicative of fraud or a valid update. Based on the evaluation, if the request is determined to be a valid update, the system generates executable instructions for the target database to apply the specified modifications. The computing architecture, thus, facilitates fraud-aware data record management by integrating machine learning-based validation within a cloud-based distributed data management framework.

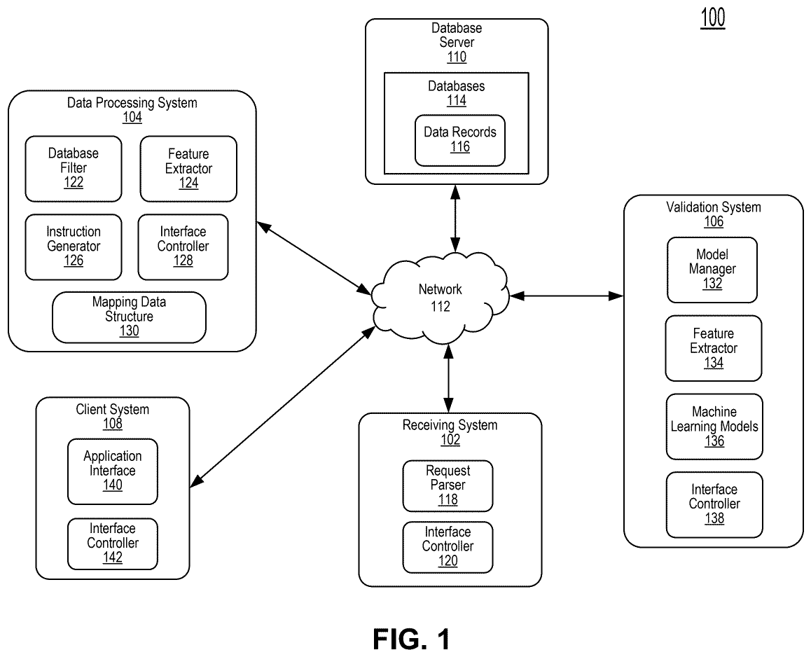

FIG. 1 depicts an example system according to one or more aspects of the technical solutions described herein. As illustrated by way of example in FIG. 1, a system 100 can include one or more of a receiving system 102, a data processing system 104, a validation system 106, a client system 108, and a database server 110. One or more components of the system 100 can communicate via network 112.

The receiving system 102 can include computing resources configured to receive and process incoming requests. The receiving system 102 can include a physical computer system operatively coupled or couplable with one or more components of the system 100. The receiving system 102 can include, host, or be hosted by or on a cloud system, a server, a distributed remote system, or any combination thereof. The receiving system 102 can include a virtual computing system, an operating system, and a communication bus to effect communication and processing. The receiving system 102 can include physical infrastructure, such as physical servers, storage devices, and network equipment housed in data centers. The receiving system 102 can include a virtual computing system, which can include cloud-based virtual machines or containers for running applications and services. The receiving system 102 can include an operating system that can function as the core manager, allocating resources, configuring processes, and maintaining seamless interaction between hardware and applications. The receiving system 102 can include a communication bus that can facilitate communication between different components within the system. The receiving system 102 can be configured for network connectivity to facilitate communication and data exchange with external systems.

The receiving system 102 can be or include a request processing system configured to execute tasks such as request parsing, authentication, and preliminary data validation, among others. The receiving system 102 can distribute incoming requests across multiple processing units to enhance load balancing and resource utilization. The receiving system 102 can be or include a web server to function as an entry point for requests. The receiving system 102 can accept connections from clients (e.g., user interfaces, other systems). The receiving system 102 can transmit the request to internal components or external components within system 100 for further processing. In another aspect, the receiving system 102 can be or include an application programming interface (API) gateway to provide a centralized interface for external systems to perform data modification and synchronization operations. The receiving system 102 can enforce API authentication, authorization, rate limiting, and request transformation policies, among others. The receiving system 102 can direct incoming requests to the appropriate backend services or processing components for execution. In yet another aspect, the receiving system 102 can be or include a message queue system to store incoming requests in a message queue to enhance throughput, fault tolerance, and system scalability. The receiving system 102 can allow backend components to process messages at a controlled rate, independent of the request arrival pattern. The specific implementation of the receiving system 102 can be selected based on various factors, such as the expected volume of requests, the security requirements of the system, the complexity of the initial processing steps, or the system architecture.

The data processing system 104 can include computing resources configured to execute data processing operations and manage administrative workflows. The data processing system 104 can include a physical computer system operatively coupled or couplable with one or more components of the system 100. The data processing system 104 can include, host, or be hosted by or on a cloud system, a server, a distributed remote system, or any combination thereof. The data processing system 104 can include a virtual computing system, an operating system, and a communication bus to effect communication and processing. The data processing system 104 can include physical infrastructure, such as physical servers, storage devices, and network equipment housed in data centers. The data processing system 104 can include a virtual computing system, which can include cloud-based virtual machines or containers for running applications and services. The data processing system 104 can include an operating system that can function as the core manager, allocating resources, configuring processes, and maintaining seamless interaction between hardware and applications. The data processing system 104 can include a communication bus that can facilitate communication between different components within the system. The data processing system 104 can be configured to connect with external systems to allow for data exchange and service delivery to end users.

The data processing system 104 can be, include, execute, or host a payroll system configured to manage employee compensation, deductions, tax calculations, and other payroll-related updates. The data processing system 104 can be, include, execute, or host a human resources (HR) system configured to manage employee information, including personal details, job history, performance reviews, benefits enrollment, and beneficiary designations, among others. The data processing system 104 can be, include, execute, or host a talent management system configured to manage employee talent, including recruitment, performance management, training, and succession planning, among others. The data processing system 104 can be or include a time and benefits administration system configured to manage employee time tracking, leave requests, vacation time, sick leave, and changes to benefits selections, among others. The data processing system 104 can be a more generalized administrative system, incorporating functionalities from multiple domain-specific systems as described above. The architecture and configuration of the data processing system 104 can be determined based on organizational requirements, data complexity, and the level of interoperability desired between various administrative functions.

The data processing system 104 can be configured to implement batch processing pipelines for data governance, compliance enforcement, and historical state tracking. These pipelines can periodically process captured data snapshots stored in the database server 110, audit logs, or storage repositories to evaluate state transitions, applied modifications, and event-driven updates across the distributed database system. For example, the data processing system 104 can evaluate historical data states to track how data records 116 have changed over time, identify modification patterns, and determine causal factors influencing these changes. The batch processing can log detailed metadata associated with each modification, including source IP addresses, timestamps, event triggers, transaction IDs, and user authentication credentials. The recorded metadata can support audit logging, forensic data analysis, and compliance validation. The audit trail can function as a structured record of data-related events, allowing the validation system 106 to perform anomaly detection, security incident investigation, and regulatory compliance enforcement based on historical data modifications.

The data processing system 104 can be, include, execute, or host a wrapper component implemented as a composite service layer around a series of microservices. The wrapper component can be configured to manage sequential or trigger-based data processing workflows in response to defined events, such as open enrollment periods, life events (e.g., birth, marriage, death), and employment status changes (e.g., new hire, leave of absence, termination). Upon activation, the wrapper component can initiate microservices configured to capture, collect, save, and compare structured data entities. Such entities can include personally identifiable information (PII) across employment records, emergency contact information, dependent and beneficiary information across multiple service providers, and service enrollment data including paid and optional services offered by an employer. The microservices can communicate via the communication bus and interface with the database server 110 and other subsystems to maintain updated and reconciled data records 116. For example, the data processing system 104 can compare current beneficiary information across benefits systems and flag discrepancies during enrollment updates. During batch processing pipelines, for example, when performing data reconciliation or evaluating historical modifications across distributed nodes, the data processing system 104 can incorporate concurrency control mechanisms to mitigate race conditions. Race conditions can occur when the outcome of multiple concurrent operations on the same data depends on the unpredictable order in which those operations execute. The concurrency control mechanisms can maintain the consistency of the data processing operation regardless of the timing of concurrent updates.

The wrapper component can be configured to respond to API-based queries by initiating a data retrieval process across distributed data sources within the system 100. In response to an API query identifying information such as a first name, last name, social security number (SSN), or other identifiers, the wrapper component can verify the submitted personally identifiable information (PII) against authoritative data records 116. Upon successful verification, the wrapper component can initiate one or more microservices to crawl internal systems, including employment, benefits, and enrollment databases 114, to identify matching data records 116. The wrapper component can extract data elements, including beneficiary designations, elected benefits, and service enrollment information across various systems of record, among others. The wrapper component can then return a unified, normalized data representation to the requesting entity via the API response, facilitating downstream processing or display by other components of the system 100.

The validation system 106 can include computing resources configured to perform validation checks on data requests. For example, the validation system 106 can evaluate data requests for indications of fraud. The validation system 106 can include a physical computer system operatively coupled or couplable with one or more components of the system 100. The validation system 106 can include, host, or be hosted by or on a cloud system, a server, a distributed remote system, or any combination thereof. The validation system 106 can include a virtual computing system, an operating system, and a communication bus to effect communication and processing. The validation system 106 can include physical infrastructure, such as physical servers, storage devices, and network equipment housed in data centers. The validation system 106 can include a virtual computing system, which can include cloud-based virtual machines or containers for running applications and services. The validation system 106 can include an operating system that can function as the core manager, allocating resources, configuring processes, and maintaining seamless interaction between hardware and applications. The validation system 106 can include a communication bus that can facilitate communication between different components within the system. The validation system 106 can be configured for network connectivity to facilitate communication and data exchange with external systems.

The validation system 106 can be or include a dedicated validation server, which can host various validation components, including rule-based processing engines, machine learning models, and database integration interfaces, among others. The validation system 106 can be or include a rule-based engine configured to execute predefined rules on the data update requests to identify invalid or fraudulent requests. The validation system 106 can be or include a machine learning-based fraud detection system configured to execute one or more machine learning models to identify patterns and anomalies indicative of fraudulent activity. The machine learning models can be any suitable type, such as neural networks, support vector machines, or decision trees, among others. The validation system 106 can combine rule-based and machine learning-based approaches to enhance validation processes. In this regard, rule-based mechanisms can execute deterministic checks for rapid verification, while machine learning models can perform probabilistic analysis to detect complex and nuanced fraud pattern. The validation system 106 can integrate with a third-party validation and fraud detection service. The third-party service can implement specialized validation algorithms and utilize real-time intelligence feeds to enhance detection accuracy. The validation system 106 can access various data sources, including databases (e.g., internal and external), external APIs, and real-time data feeds, to perform validation checks. The architecture and configuration of the validation system 106 can be determined based on validation criteria, resource constraints, and target accuracy and performance thresholds.

The client system 108 (also referred to herein as a client device 108) can include a computing system that can be used to access the functionality of the receiving system 102, the data processing system 104, the validation system 106, and the database server 110. The client system 108 can include a smart phone, mobile device, laptop computer, desktop computer, one or more servers, or any other type of computing device. The client system 108 can include at least one processor and a memory, e.g., a processing circuit. The memory can store processor-executable instructions that, when executed by the processor, cause the processor to perform one or more of the operations described herein. The processor can include a microprocessor, an ASIC, an FPGA, etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, ROM, RAM, EEPROM, EPROM, flash memory, optical media, or any other suitable memory from which the processor can read instructions. The instructions can include code from any suitable computer programming language.

The client system 108 can include one or more devices to receive input from a user or to provide output to a user. For example, the output capabilities of the client system 108 can be presented through a display device that provides visual feedback to the user. The display device can enhance the user experience with electronic displays, such as liquid crystal displays (LCD), light-emitting diode (LED) displays, or organic light-emitting diode (OLED) displays. The electronic displays can implement interactive features, including capacitive or resistive touch input, allowing for multi-touch functionality. The input functionalities can include a keyboard, mouse, or an integrated touch-sensitive panel on the display device, but are not limited thereto. Each client device 108 can be associated with an identifier used to identify devices or user profiles operating the client devices 108. The identifier can be of one or more forms, such as a device ID, which can be a code assigned to the client device 108 by the manufacturer or operating system, a MAC address, which can be a hardware address assigned to the client device's network interface, or an IP address, which can identify the client device 108 on a network. The identifier can be a user ID associated with the user profile operating the client device 108, or a session ID, which can be a temporary identifier assigned to a specific session. Other identifiers, such as a serial number, can be used depending on the system and device configuration.

The client system 108 can execute an application that communicates with the receiving system 102, the data processing system 104, the validation system 106, and the database server 110. The application can present one or more application interfaces 140. The application interface 140 can include a set of rules or protocols that allow different software programs or systems to communicate with each other. The application interface 140 can provide user interfaces to facilitate interaction. For example, the application interface 140 can support text-based interactions or voice-based interactions. Users can input information, view content, or initiate actions through the application interface 140. The application interface 140 can be associated with a particular client application that communicates with the receiving system 102, the data processing system 104, the validation system 106, and the database server 110 to process user prompts. The client application can include an application executing on each client system 108. The client application can include a web application, a server application, a resource, a desktop, or a file. The client application can include a local application (e.g., local to a client system 108), a hosted application, a software-as-a-service (Saas) application, a virtual application, a mobile application, and other forms of content. The client application can include or correspond to applications provided by remote servers or third-party servers.

The client system 108 can include, interface with, communicate with, or otherwise utilize an interface controller 142. The interface controller 142 within the client system 108 can be similar to, and include any of the structure and functionality of, the interface controller 120 described in connection with the receiving system 102, the interface controller 128 described in connection with the data processing system 104, or the interface controller 138 described in connection with the validation system 106. For example, the interface controller 142 within the client system 108 can communicate with the receiving system 102, the data processing system 104, the validation system 106, or the database server 110 via the network 112 using one or more communication interfaces to carry out the various operations described herein. The interface controller 142 can be compatible with particular content objects and can be compatible with particular content delivery systems corresponding to particular content objects, structures of data, types of data, or any combination thereof.

The database server 110 can be or include a combination of hardware and software components configured to store and manage one or more databases 114. The database server 110 can be implemented as a single physical server, a cluster of servers, a virtualized server environment, a cloud-based database service, or any combination thereof. The database server 110 can provide data persistence, retrieval, and manipulation functionalities based on instructions from other components of system 100. The database server 110 can be deployed as a distributed database system, where data is distributed across multiple interconnected servers to enhance performance, scalability, and fault tolerance. In a cloud-based implementation, the database server 110 can be a managed database service, providing scalable storage, automated administration, and high availability. The database server 110 can implement a hybrid architecture that integrates multiple database technologies to enhance data storage and retrieval based on system requirements. The database server 110 can be implemented as a repository for data records 116 to implement persistent storage and controlled access through mechanisms such as authentication, authorization, and access control lists. The database server 110 can receive and execute instructions from other system components to perform operations such as storing, retrieving, updating, and deleting data records 116 within databases 114.

The database server 110 can include, interface with, communicate with, or otherwise utilize one or more databases 114 (also referred to herein as a database 114). The database 114 can be a computer-readable memory that can store or maintain any of the information described herein. The database 114 can store any data associated with the system 100. The database 114 can include one or more hardware memory devices to store binary data, digital data, or the like. The database 114 can include one or more electrical components, electronic components, programmable electronic components, reprogrammable electronic components, integrated circuits, semiconductor devices, flip flops, arithmetic units, or the like. The database 114 can include at least one of a non-volatile memory device, a solid-state memory device, a flash memory device, or a NAND memory device. The database 114 can include one or more addressable memory regions disposed on one or more physical memory arrays. A physical memory array can include a NAND gate array disposed on, for example, at least one of a particular semiconductor device, an integrated circuit device, or a printed circuit board device. The database 114 can correspond to a non-transitory computer readable medium. The non-transitory computer readable medium can include one or more instructions executable by a processor of the database server 110 to perform operations such as storing, retrieving, updating, and managing data records 116 stored within the database 114.

The database 114 can be distributed across multiple physical, virtualized, or hybrid infrastructures, with each database 114 instance corresponding to a specific operational domain, such as payroll, HR, benefits, beneficiary, or time and attendance management. The distribution of database 114 can be implemented based on geographic locations, regulatory requirements, data security policies, network latency considerations, and infrastructure capabilities to enhance data availability and processing efficiency. In some cases, regional database clusters can be deployed within data centers located in distinct geographic areas to support low-latency access, data redundancy, and failover mechanisms. Each region can maintain database instances to facilitate compliance with local data sovereignty laws, regulatory frameworks such as GDPR, CCPA, or HIPAA, and jurisdictional data processing mandates. The regional instances can integrate with localized authentication and authorization protocols to maintain compliance with regional requirements. The database 114 can be implemented as multi-tenant cloud-based databases 114 using logical partitioning that isolates data based on organizational units, subsidiaries, or regulatory zones. Each tenant's database 114 instance can be assigned encryption keys, data schemas, and granular access control policies to maintain data segmentation and protect against unauthorized access.

In distributed architectures, database sharding can be implemented to partition datasets across multiple database nodes based on geographic regions, data types, or business entities. For example, payroll data for employees in different time zones can be sharded by region-specific clusters, allowing processing schedules to align with local payroll cycles. Similarly, HR databases can be partitioned by employment classification, organizational hierarchy, or department-specific data silos to reduce query latency and enhance resource allocation. In some cases, beneficiary databases can be segmented by jurisdictional policies, financial institutions, or benefits administration systems to facilitate automated processing of dependent enrollments, payout distributions, and compliance validation. For example, a beneficiary database associated with life insurance or retirement plans can be partitioned by financial service providers to establish seamless data exchange between insurance carriers, employer-sponsored plans, and payroll systems.

In cloud-based deployments, the database 114 can be implemented as a serverless database service that dynamically allocates storage and compute resources based on real-time workload demands using techniques such as container orchestration and function-as-a-service. The database 114 can automatically scale horizontally and vertically to accommodate fluctuations in query volume, including sudden spikes, predictable variations, and unpredictable bursts of concurrent user requests. The database 114 can implement cross-region data synchronization mechanisms using technologies such as event-driven architectures and distributed messaging systems to maintain data consistency and integrity across decentralized infrastructures. The database 114 can implement blockchain-based transaction ledgers for specific use cases demanding enhanced auditability and immutability.

The database 114 can store or maintain one or more data structures, which can include containers, indices, or otherwise store each of the values, pluralities, sets, variables, vectors, numbers, or thresholds described herein. The database 114 can be accessed using one or more memory addresses, index values, or identifiers of any item, structure, or region maintained in the database 114. The database 114 can be accessed by the components of the receiving system 102, the data processing system 104, the validation system 106, the client system 108, or any other computing device described herein, via the network 112. For example, the database 114 can be distributed across many different computer systems (e.g., a cloud computing system) or storage elements and can be accessed via the network 112 or a suitable computer bus interface.

Each database 114 of the one or more databases 114 can store or maintain a respective data record 116 associated with a profile data structure. Each data record 116 can include a plurality of field-value pairs. The data record 116 can include a structured representation of an entity (e.g., user profile, organization, product, or a system). For example, the data record 116 associated with a user profile data structure can include field-value pairs for payroll-related data, such as personal details (e.g., name, address, social security number, date of birth), employment information (e.g., job title, hire date, department, work location), compensation data (e.g., salary, hourly wage, overtime rate, bonuses, commissions), tax information (e.g., federal, state, and local tax withholdings, exemptions, deductions), benefits data (e.g., health insurance, retirement plans, paid time off, disability insurance, beneficiary designations, dependent coverage), time tracking details (e.g., hours worked, overtime, sick leave, vacation time), payroll deductions (e.g., contributions to retirement plans, health insurance premiums, union dues, garnishments), deposit information (e.g., bank account details for paycheck deposits), performance assessments (e.g., annual evaluations, competency assessments, goal achievements), termination records (e.g., termination date, reason for termination, severance details), and government reporting data (e.g., forms like W-2, 1099), among others.

Each data record 116 associated with a profile data structure can include attributes with specific data types (e.g., name: string, salary: decimal). Each attribute, specifying a field in the field-value pair, can have a specific data type, such as a string, integer, date, or Boolean. The data record 116 can organize entities in a hierarchical structure, where one entity acts as a parent to multiple child entities (e.g., a company profile having a hierarchical relationship with department profiles, and department profiles having hierarchical relationships with employee profiles). The data record 116 can include metadata such as creation date, modification timestamps, data source, and ownership, among others. The data record 116 can be associated with other data structures or entities via identifiers, such as an employee ID or a social security number. The identifier can associate the data record 116 associated with the profile data structure with corresponding records, providing access to related information for querying and data retrieval.

The data record 116 can maintain relationships with other data structures to establish connections and associations between entities within a complex organizational framework. The data record 116 can integrate information across various databases 114, including payroll, HR, benefits, beneficiary, and time and attendance databases, among others. The data record 116 can specify hierarchical structures by associating a parent company with its sub-organizations distributed across multiple geographic locations. The data record 116 can define a one-to-one relationship, where a user identity data record can have a one-to-one association with an authentication credential record. The data record 116 can establish a one-to-many relationship, where a parent company record can be associated with multiple sub-organization data records, or a department record can be associated with multiple employee data records. The data record 116 can also support a many-to-many relationship, where an employee data record can be associated many-to-many with project data records or with benefits plan data records. The data record 116 can function as a central point of reference. For example, the data record 116 can associate data distributed across HR, payroll, benefits, and time management systems through associations with databases 114. The data record 116 can associate a user profile data structure with regulatory compliance data structures, such as regional tax laws, payroll policies, or benefits regulations. Such associations can be implemented using structured indexing, foreign key constraints, lookup tables, or references to external regulatory data sources. For example, an employee data record can be associated with specific benefits plans, payroll deductions, and tax withholdings, drawing data from the benefits, payroll, and HR databases.

The receiving system 102 can include, interface with, communicate with, or otherwise utilize a request parser 118. The request parser 118 can be or include any script, file, program, application, set of instructions, or computer-executable code that can be configured to receive, interpret, and structure incoming requests. The request parser 118 can be implemented using various techniques, including, but not limited to, lexical analysis, syntactic analysis, and semantic analysis. The request parser 118 can utilize regular expressions, context-free grammars, tokenization methods, or other parsing algorithms to parse a request into its constituent components. The request parser 118 can process various request formats, such as JSON, XML, or custom formats, and can be extended to support new or proprietary data formats. The request parser 118 can identify and extract various parameters from the request, such as identification parameters (used to identify the data record) and update parameters (specifying the changes to be applied). The request parser 118 can be configured to perform validation checks, including verifying required parameters, enforcing data type constraints, applying schema validation rules, and detecting malformed requests. The request parser 118 can generate structured outputs suitable for further processing by other components of system 100. The structured output can be formatted as key-value mappings, object representations, data trees, or any other data structure that facilitates efficient access, manipulation, and transmission within the system. The request parser 118 can be configured to transmit the request to the data processing system 104 or the validation system 106 for further processing and validation, based on system architecture and implementation parameters. The functionalities associated with the request parser 118 can be performed by the data processing system 104 to streamline processing.

The request parser 118 can process one or more incoming requests corresponding to data update operations within a distributed database system. A data update request can refer to a request to modify, add, or delete specific data elements within data records 116 stored in the distributed database system. The request parser 118 can extract parameters from a data update request to facilitate identification and modification of data records 116 within databases 114. For example, the request parser 118 can extract identification parameters that define a target data record 116 stored in a target database 114. The identification parameters can include an identifier (e.g., primary key associated with a beneficiary record), a timestamp (e.g., record creation time or last modification timestamp), a location reference (e.g., geographic region associated with a beneficiary's jurisdiction or storage partition in a distributed database), an entity type (e.g., employee, department, company, beneficiary, policyholder, or insurance provider), or a transaction type (e.g., new beneficiary enrollment, beneficiary update, or removal of a dependent). The request parser 118 can extract update parameters that specify modifications to be applied to the identified data record 116. For example, the request parser 118 can process updates that include a modification of field values (e.g., updating a beneficiary's contact details), an addition of new fields (e.g., appending a beneficiary to an insurance policy record), a deletion of existing fields (e.g., removing an outdated beneficiary designation), or a modification of relationships between data records (e.g., updating the primary beneficiary on a policy due to a life event, such as marriage, divorce, or the birth of a child). The request parser 118 can generate data objects, populate structured data models, or generate intermediate representations to standardize the update request for downstream processing components.

The request parser 118 can receive a data update request based on various triggering events. These triggering events can initiate the process of updating a data record 116 associated with a profile data structure, such as adding or modifying beneficiary information. The request parser 118 can process events corresponding to data modification events within databases 114. A data modification event can occur when a request is submitted or an update is initiated for an existing data record 116. For example, a client device 108 can transmit a request to update a data record 116 associated with a profile data structure. The request can trigger a data update event, which the request parser 118 can receive, parse, and extract relevant beneficiary details, including name, relationship, and percentage allocation, along with the identifier associated with the profile data structure. The request parser 118 can process events corresponding to data generation events within databases 114. A data generation event can occur when a data record 116 is provisioned within the database 114. For example, when a new profile data structure is provisioned in the database 114 (e.g., HR database), the system 100 can generate an initial record including relevant field-value pairs, such as profile ID, name, role, and status, among others. As part of the onboarding process, the profile data structure can be associated with beneficiary information, triggering a data update request with additional field-value pairs, such as beneficiary name, relationship, and allocation, among others. The request parser 118 can process the request and extract beneficiary details for further processing.

The request parser 118 can process events corresponding to data synchronization events between databases 114 and an external system. A data synchronization event can arise when the database 114 synchronizes with external data platforms. For example, an organization can use a third-party benefits administration platform, where an update to a beneficiary record on the external system can trigger a synchronization event. The synchronization event can generate a data update request to update the relevant database 114. The request parser 118 can receive the request and extract the beneficiary details for further processing. The request parser 118 can process scheduled data processing events, which can be triggered based on a predefined execution schedule. For example, the system 100 can include a scheduled process that evaluates profile data structures for missing or incomplete field-value pairs. If a profile data structure lacks required beneficiary information, for example, the system can generate a data update request to prompt an employee to provide beneficiary details. The request parser 118 can extract the relevant parameters and structure them for further processing. The request can include executable instructions, dynamically generated links, or system-generated prompts that direct a client device 108 to complete the beneficiary designation process through an interactive application interface 140.

The receiving system 102 can include, interface with, communicate with, or otherwise utilize an interface controller 120. The interface controller 120 within the receiving system 102 can be similar to, and include any of the structure and functionality of, the interface controller 128 described in connection with the data processing system 104, the interface controller 138 described in connection with the validation system 106, or the interface controller 142 described in connection with the client system 108. For example, the interface controller 120 within the receiving system 102 can communicate with the data processing system 104, the validation system 106, the client system 108, or the database server 110 via the network 112 using one or more communication interfaces to carry out the various operations described herein. The interface controller 120 can be compatible with particular content objects and can be compatible with particular content delivery systems corresponding to particular content objects, structures of data, types of data, or any combination thereof.

The data processing system 104 can include, interface with, communicate with, or otherwise utilize a database filter 122. The database filter 122 can be or include any script, file, program, application, set of instructions, or computer-executable code that can be configured to filter a target database 114 from a plurality of databases 114 based on the data update request. The database filter 122 can evaluate an incoming data update request and, based on the request's characteristics, identify the appropriate database 114 storing the relevant data. The database filter 122 can implement various filtering techniques, including evaluating metadata associated with databases 114, evaluating data partitioning schemes, applying predefined rules or policies, referencing a directory or index of data locations, or querying a distributed data catalog. The database filter 122 can assess various attributes of the data update request, such as identifiers within the request, the type of data being updated, the source of the request, or other contextual parameters relevant to database selection.

The database filter 122 can utilize identification parameters extracted from the data update request to determine the target database 114 for processing the data update request. The database filter 122 can evaluate relevant identification parameters, such as region ID, department code, or profile data structure ID (e.g., policyholder ID, employee ID, or user profile ID), to map the request to the corresponding database 114 associated with that specific geographic region, organizational unit, profile data structure, or target data record 116 for the update. The mapping can be performed using lookup tables, configuration files, or dynamic routing mechanisms that associate identification parameters with specific database instances, which are maintained in a distributed computing environment, such as a cloud-based infrastructure, a network of interconnected servers, or geographically separated data centers, and store profile data structures, beneficiary records, policyholder information, or other entity-specific data relevant to the update request. A distributed computing environment can include multiple independent computing nodes communicating over a network. Such geographically separated systems can collaborate using various technologies for parallel processing and scalability, among others.

The database filter 122 can also reference the profile data structure associated with the data record 116 targeted for the update. Different profile data structures (e.g., policyholder, beneficiary) can reside in different databases 114, with each database 114 configured for a particular entity type and operational domain. The database filter 122 can use the profile type or associated user profile ID, in conjunction with the identification parameters, to determine the appropriate database 114 for executing the update operation. For example, if a data update request specifies the addition of a new beneficiary to a policyholder's profile, the database filter 122 can extract the policyholder ID and information identifying the data as belonging to a beneficiary profile data structure to select the associated beneficiary management database 114 instead of the payroll database 114. Similarly, if an update modifies an existing beneficiary allocation, the database filter 122 can verify the association between the beneficiary and the primary profile before selecting the associated policy administration database 114.

The database filter 122 can utilize a mapping data structure 130, maintained within the data processing system 104, to determine the target database 114 for a given data update request. The database filter 122 can generate a lookup query for the mapping data structure 130 using the identification parameters extracted from the request and the corresponding profile data structure. The database filter 122 can execute the query against the mapping data structure 130 to retrieve the location of the target database 114 where the data record 116 resides. For example, if the identification parameter is a policyholder ID and the profile data structure is a policyholder profile, the query can retrieve the database 114 instance, where the policyholder's data record is stored. If the request involves updating beneficiary details, the database filter 122 can use the information to identify the policyholder's record and access the associated beneficiary data stored within it or in linked tables.

The database filter 122 can operate based on data sovereignty constraints and regulatory compliance mandates. Depending on the geographic jurisdiction of the profile data structure (e.g., employee, policyholder, or beneficiary) or the classification of the data being processed, the database filter 122 can select a target database 114 that satisfies the applicable regulatory and data governance requirements. For example, the database filter 122 can identify a database 114 located within a designated geographic region or one that applies specific data processing policies based on the location of the data record 116 associated with the profile data structure in the request. The database filter 122 can apply filtering logic based on multiple selection criteria, such as geographic region, policyholder or beneficiary profile attributes, regulatory classification, and data residency constraints. Additionally, the database filter 122 can implement dynamic filtering rules that adapt to system configuration updates, changes in regulatory frameworks, or external compliance directives.

The data processing system 104 can include, interface with, communicate with, or otherwise utilize a feature extractor 124. The feature extractor 124 can be or include any script, file, program, application, set of instructions, or computer-executable code that can be configured to identify and extract relevant features from data records 116 or data update requests. The feature extractor 124 can be configured to select features based on indications of potential fraud. The feature extractor 124 can select one or more features from a set of features associated with the data record 116 to be updated. The selected features can be derived from various attributes associated with the data record 116 and can indicate fraudulent or anomalous activity. For example, frequency of data changes can be evaluated to determine modification rates within a short time window, which can indicate potential fraud. For instance, frequent changes to a beneficiary designation or address can warrant further scrutiny. The feature extractor 124 can evaluate the correlation of data with external sources by verifying whether a newly provided beneficiary address aligns with known fraudulent address databases or publicly available records, where discrepancies or matches with known fraudulent data can be strong indicators of fraud. Additionally, patterns of data access can be evaluated by detecting unusual access behaviors, such as logins from unfamiliar locations or outside of typical business hours. For example, a sudden login from a foreign location followed by a beneficiary change request can indicate anomalous activity. Temporal characteristics of the data can be evaluated, including the time since the last update, the duration since account creation, or the time of day the request was made, as irregularities. For example, a beneficiary change request submitted late at night or immediately after a long period of inactivity can be considered more suspicious.

The feature extractor 124 can apply rule-based feature engineering to identify and select features associated with the data record 116. The feature extractor 124 can use predefined rules derived from domain expertise and historical data analysis to extract features that indicate fraudulent or anomalous activity. These rules can define specific patterns or data relationships that distinguish suspicious activity. For example, if the geographic distance between the old and new address in a beneficiary designation change request exceeds a defined threshold, the feature extractor 124 selects the geographic distance feature. If the frequency of beneficiary modifications within a predefined time window surpasses a set limit, the feature extractor 124 selects the frequency of changes feature. The feature extractor 124 can cause the validation system 106 to input the extracted features into a machine learning model for further analysis and validation.

The feature extractor 124 can utilize various machine learning techniques to automatically select the most relevant features for fraud detection. A dedicated machine learning model can be trained to evaluate feature importance, or feature selection algorithms can process labeled datasets of historical data records to refine feature extraction strategies. For example, a machine learning model can determine that frequent modifications of a primary beneficiary within a short time frame correlate with potentially fraudulent activity or data inconsistencies, prompting the selection of a modification frequency feature. Additionally, the feature extractor 124, using the machine learning techniques, can identify micro-fraud indicators, such as inconsistencies in social security number (SSN) formats, repeated use of slightly altered SSNs across multiple beneficiary records, or unusual patterns in the length and structure of identification numbers. For example, if the requested beneficiary's SSN deviates from standard formatting rules or resembles an SSN previously flagged for fraudulent activity, the feature extractor 124 can select an SSN anomaly score feature for further analysis by the validation system 106.

The feature extractor 124 can incorporate data preprocessing steps, including data cleaning, normalization, transformation, and missing value imputation, to enhance the quality and consistency of extracted features. The extracted features can then be formatted into structured data representations (e.g., feature vectors, tensors, or tabular data structures) and inputted into a machine learning model executed by the validation system 106 for classification, anomaly detection, or predictive analysis. The feature extractor 124 can integrate rule-based and machine learning-based approaches, where rule-based methods extract predefined baseline features (e.g., beneficiary name, relationship, allocation percentage), while machine learning techniques select complex feature patterns, such as detecting irregular changes in allocation percentages across multiple beneficiaries.

The data processing system 104 can include, interface with, communicate with, or otherwise utilize an instruction generator 126. The instruction generator 126 can be or include any script, file, program, application, set of instructions, or computer-executable code that can be configured to generate commands for the target database 114 to execute update operations. The instructions can be dynamically generated based on validation results received from the validation system 106. The instruction generator 126 can be implemented through various techniques, including generating structured query language (SQL) statements, invoking database-specific application programming interface (API) calls, constructing data manipulation language (DML) commands, or generating messages formatted for a message queue system. The instruction generator 126 can incorporate adaptive logic to process diverse data update instances and interface with heterogeneous database management systems to facilitate compatibility with varying database architectures and operational constraints.

In some cases, if the validation result indicates that a beneficiary update request is valid, the instruction generator 126 can generate database-specific instructions to update the target database 114. Such instructions can be derived from the update parameters included in the data update request, which define the modifications to be applied to the data record 116. The update parameters can include, but are not limited to, modification of a beneficiary-related value (e.g., updating the allocation percentage assigned to a beneficiary), addition of a new beneficiary entry (e.g., adding a newly designated beneficiary to an account), deletion of an existing beneficiary record (e.g., removing a previously assigned beneficiary), and modification of a relationship between beneficiaries and account holders (e.g., updating the primary beneficiary designation). The instruction generator 126 can be configured to translate these update parameters into a format that the target database 114 can process. For example, if the update parameter specifies a change in a beneficiary's allocation percentage, the instruction generator 126 can generate an update command that causes the corresponding database 114 to modify the corresponding field in the data record 116.

In some cases, if the validation result classifies the data update request as fraudulent, the instruction generator 126 can generate a notification or a fraud alert, including metadata associated with the suspicious activity. The fraud alert can be transmitted to various system components, including the client system 108 associated with the policyholder profile data structure, security monitoring services, system administrators, or policy enforcement components. The alert payload can include details, such as the request type, detected fraud indicators, anomaly scores, and relevant contextual data extracted from the transaction. The fraud alerts can provide security analysts or automated response systems with the data to initiate corrective measures, such as triggering an investigation workflow, applying access restrictions, flagging the associated account for enhanced scrutiny, or enforcing policy-based mitigation strategies. The generated fraud alert can incorporate multidimensional information about the suspicious activity, including the classification of the request, specific indicators detected across correlated feature vectors, and model-generated anomaly scores, to provide a comprehensive input for downstream analysis and mitigation. The alert payload can include insights derived from aggregate behavior patterns identified across multiple organizational systems associated with a common benefits provider. The fraud alerts can provide security analysts or automated response systems with the information required to initiate remediation workflows, execute access control policies, flag the profile data structure for additional scrutiny, or apply rule-based mitigation strategies, among others.

The data processing system 104 can include, interface with, communicate with, or otherwise utilize an interface controller 128. The interface controller 128 can be or include any script, file, program, application, set of instructions, or computer-executable code that can be configured to facilitate communication among the receiving system 102, the data processing system 104, the validation system 106, the client system 108, and the database server 110. The interface controller 128 can include hardware, software, or any combination. The interface controller 128 within the data processing system 104 can be similar to, and include any of the structure and functionality of, the interface controller 120 described in connection with the receiving system 102, the interface controller 138 described in connection with the validation system 106, or the interface controller 142 described in connection with the client system 108.

The interface controller 128 can facilitate communication among the receiving system 102, the data processing system 104, the validation system 106, the client system 108, and the database server 110 via one or more communication interfaces. A communication interface can include, for example, an application programming interface (“API”) compatible with a particular component of the receiving system 102, the data processing system 104, the validation system 106, the database server 110, or the client system 108. The communication interface can provide a particular communication protocol compatible with a particular component of the receiving system 102, a particular component of the data processing system 104, a particular component of the validation system 106, a particular component of the database server 110, or a particular component of the client system 108. The interface controller 128, accessible via an API, can coordinate data exchange between the plurality of databases 114 managed by the database server 110. The coordination can include routing data requests to the appropriate database instance, aggregating results from multiple databases 114, and maintaining data consistency across the distributed database environment. The API can provide a standardized interface for external systems and internal components to interact with the distributed databases 114. The interface controller 128 can be compatible with particular content objects and can be compatible with particular content delivery systems corresponding to particular content objects, structures of data, types of data, or any combination thereof. For example, the interface controller 128 can be compatible with the transmission of structured or unstructured data according to one or more metrics.

The data processing system 104 can include, interface with, communicate with, or otherwise utilize a mapping data structure 130. The mapping data structure 130 can be implemented as any suitable data structure, including, but not limited to, a hash table, a B-tree, a relational database table, a distributed cache, or any combination thereof. The mapping data structure 130 can reside in memory, on persistent storage, or be distributed across multiple nodes in a distributed system. The mapping data structure 130 can maintain associations between identification parameters, the associated profile data structure, and the locations of corresponding data records 116, such as beneficiary-related data records 116. The identification parameters, extracted from data update requests, can function as lookup keys, along with the profile data structure, to identify the location of the target data record 116 for modifications. The mapping data structure 130 can associate these keys and the profile data structure with the specific database 114 instance and the specific storage location (e.g., table name, row ID) within that database 114 where the data record 116 resides. For example, if the identification parameters include a policyholder ID and the profile data structure is a policyholder profile, the mapping data structure 130 can store a mapping between the policyholder ID, the policyholder profile data structure, and the storage location of the policyholder's data record 116 within the distributed database system. The data record location can specify the database 114 instance and specific storage location where policyholder-related details or beneficiary-related details are maintained as part of the policyholder's record. For example, the mapping data structure 130 can store a mapping between the beneficiary's identification (e.g., a beneficiary ID), a beneficiary profile data structure, and the storage location of the beneficiary's data record 116, and can link this mapping back to the policyholder ID. Such details can include allocation percentages, designated beneficiaries, and benefit distributions, which can be structured as relational entries or nested attributes under the beneficiary's profile or linked to the policyholder's profile. In some cases, different profile data structures (e.g., policyholder profile, dependent profile) can be stored in separate databases or different partitions, while linking back to the same policyholder ID or other relevant identifiers to establish relationships between the entities.

The mapping data structure 130 can be dynamically updated as data records 116 are generated, modified, or relocated within the distributed database system, such that the mapping data structure 130 provides the current state of the data record 116 and maintains an accurate reference to the location of each data record 116 in the target database 114 across distributed databases. The data processing system 104 can maintain consistency within the mapping data structure 130 by synchronizing the mapping data structure 130 with databases 114 at regular intervals, applying event-driven updates initiated by data modifications, or using a hybrid approach. The data processing system 104 can partition the mapping data structure 130 for workload distribution and improve fault tolerance.

The validation system 106 can include, interface with, communicate with, or otherwise utilize a model manager 132. The model manager 132 can train, fine-tune, update, re-train, or otherwise maintain one or more machine learning models 136. The model manager 132 can include hardware, software, or any combination thereof. The model manager 132 can reside within the validation system 106, where the model manager 132 can manage and coordinate the training, fine-tuning, and updating of the machine learning models 136. The model manager 132 can exist outside the validation system 106, operating as a remote service that interacts with the receiving system 102, the data processing system 104, the validation system 106, the client system 108, and the database server 110 via interface controller 138. The model manager 132 can facilitate the training of machine learning models 136 on training datasets and can fine-tune the machine learning models 136 for specific tasks or domains. The model manager 132 can manage the deployment of machine learning models 136 in production environments and the integration of machine learning models 136 with other systems and services.

The model manager 132 can monitor the performance of deployed machine learning models 136, identify issues, and update machine learning models 136. The model manager 132 can utilize various machine learning algorithms, including supervised learning techniques, to train, fine-tune, or update one or more machine learning models 136 using labeled data or training datasets to improve the prediction accuracy and classification capabilities of the machine learning models 136. The model manager 132 can implement unsupervised learning techniques, such as clustering and association rule mining, to identify patterns in unlabeled data, or to generate labels for said unlabeled data. The model manager 132 can implement reinforcement learning techniques to update the machine learning models 136 based on user-provided feedback or training datasets.

The model manager 132 can train the machine learning model 136 using a training dataset, including a plurality of data records and corresponding classification labels. Each data record can specify an instance of a data update request or a data record subject to modification. Each data record in the training dataset can correspond to any data record 116 maintained within the plurality of databases 114 on the database server 110 that may be updated or modified as part of the data processing workflow. The training dataset can include a set of features extracted from the data records 116 maintained within the plurality of databases 114. These features can include, but are not limited to, frequency of data changes, correlation of data with external sources, patterns of data access, temporal characteristics of data, and other features indicative of fraudulent activity. Each record in the training dataset can be associated with a label indicating whether the record or the corresponding request is fraudulent or valid. The machine learning model 136 can be configured to learn feature-label correlations and infer decision boundaries that distinguish between legitimate and fraudulent update requests. The model manager 132 can apply dataset balancing techniques, such as oversampling underrepresented classes or weighting loss functions, to mitigate bias and improve classification performance. For example, the model manager 132 can adjust the training dataset to maintain an adequate representation of both fraudulent and valid data update requests to improve model generalization and predictive accuracy.

The model manager 132 can train the machine learning model 136 to identify various indicators of fraud, including, but not limited to, anomalous data access patterns, unauthorized data modifications, and correlations with known fraudulent data sources, among others. Each input data record can be labeled as fraudulent or valid, allowing the machine learning model 136 to learn associations between specific feature combinations and fraudulent activity. The model manager 132 can train the machine learning model 136 to detect fraudulent events that indicate attempts to manipulate or compromise data integrity. These events can be identified through patterns in the data, such as a sudden increase in the frequency of beneficiary changes, repeated modifications to social security numbers (SSNs) with slight variations, or alterations in bank account details immediately following a login from an unfamiliar location. Other micro-fraud indicators can include inconsistencies in personally identifiable information (PII), such as mismatches between an SSN and other identity attributes, usage of synthetic identities, or attempts to reuse previously flagged fraudulent details. The model manager 132 can re-train the machine learning model 136 periodically or in response to newly labeled fraud cases to maintain detection accuracy and adapt to evolving fraud tactics.

After training the machine learning model 136, the model manager 132 can evaluate the model's performance using a validation dataset that is separate from the training dataset. The validation dataset can include unseen data records along with their corresponding classification labels. The model manager 132 can evaluate the trained machine learning model 136 by measuring its ability to classify new data update requests as fraudulent or valid. The model manager 132 can compute evaluation metrics, such as accuracy, precision, recall, and F1-score, to quantify the model's classification performance.

The validation system 106 can include, interface with, communicate with, or otherwise utilize a feature extractor 134. The feature extractor 134 within the validation system 106 can be similar to, and include any of the structure and functionality of, the feature extractor 124 described in connection with the data processing system 104. The feature extractor 134 within the validation system 106 can receive features associated with the data record 116 to be updated from the data processing system 104. The feature extractor 134 within the validation system 106 can receive the data update request from the receiving system 102 and extract one or more relevant features from the set of features associated with the data record 116 targeted for update. The feature extractor 134 can preprocess and structure the extracted features before inputting them into the machine learning model 136 for validation and fraud detection. The feature extractor 134 can implement various feature selection techniques, including rule-based feature engineering, machine learning-based feature selection, or a hybrid approach that integrates both methods. The selection of features and the extraction techniques implemented can be dynamically determined based on the characteristics of the data update request (e.g., whether the request was made immediately after a password reset or from an unfamiliar device), the structural attributes of the data record 116 (e.g., comparing the new bank account details with previously linked accounts or checking for inconsistencies in account ownership), and the operational requirements of the machine learning model 136 to enhance fraud detection accuracy.

The validation system 106 can include, interface with, communicate with, or otherwise utilize various machine learning models 136 (also referred to herein as a machine learning model 136). The machine learning model 136 can be deployed within the data processing system 104, within the validation system 106, or externally as remote services. The machine learning models 136 can be trained with the same or different types of machine learning techniques, trained with the same or different types of training data, or trained or configured to receive different types of input or provide different types of output. Example machine learning techniques can include neural networks, such as a generative adversarial network (e.g., a generator neural network and a discriminator neural network that are trained simultaneously through adversarial training), a variational autoencoder (e.g., an autoencoder neural network that learns to generate new data samples by modeling the underlying probability distribution of the data), an autoregressive model, or other types of neural networks (e.g., deep learning models, convolutional neural networks, recurrent neural networks, or transformers). Transformers can refer to or include a type of deep learning model architecture configured for natural language processing, including, for example, bidirectional encoder representations (“BERT”), generative pre-trained transformers, text-to-text transformers, transformer-XL, robustly optimized BERT, or distilled BERT. Other types of machine learning techniques can include supervised learning models, unsupervised learning models, semi-supervised learning models, or reinforcement learning models. For example, a supervised machine learning technique can include a support vector machine used for classification and regression tasks. Given a set of labeled training data, a support vector machine can identify the hyperplane that separates the data into classes with the largest possible margin (e.g., distance between the hyperplane and nearest data points from each class).

The machine learning model 136 can be trained to determine, based on the features associated with the data record 116 to be updated, whether a data update request is indicative of an instance of fraud or a valid update request. The machine learning model 136 can derive this determination by evaluating patterns and identifying anomalies in the extracted features. The machine learning model 136 can be trained, updated, or fine-tuned to perform a variety of classification tasks, including, but not limited to, binary classification (fraudulent/valid), multi-class classification (categorizing different types of fraud), or regression (assigning a fraud likelihood score to a request). The machine learning model 136 can implement various architectures, such as feedforward neural networks, recurrent neural networks (RNNs), long short-term memory (LSTM) networks, and transformer-based models. For example, a transformer-based model can process input features using an encoder network, where self-attention mechanisms assign varying levels of importance to different features when generating fraud predictions. The machine learning model 136 can include multiple layers, such as embedding layers (to convert categorical features into numerical representations), attention layers (to weigh the importance of different features), and feedforward layers (to capture complex feature interactions). Additionally, the machine learning model 136 can be trained, fine-tuned, or updated using various learning techniques, such as supervised learning with labeled datasets, semi-supervised learning utilizing labeled and unlabeled data, and unsupervised anomaly detection models that identify deviations from normal data patterns. For anomaly detection, techniques such as autoencoders and generative adversarial networks (GANs) can be integrated into a broader supervised or semi-supervised learning framework to enhance fraud detection.

The validation system 106 can utilize the trained machine learning model 136 to compute the likelihood of fraud for a given data update request. For example, upon receipt of a request to update a data record 116, the validation system 106 can extract a corresponding subset of features associated with the respective data record 116 and input the corresponding subset of features into the machine learning model 136. The machine learning model 136, trained on labeled data to identify patterns indicative of fraudulent activity, can process the extracted feature set and generate a fraud likelihood score. The fraud likelihood score can quantify the model's confidence in classifying the request as fraudulent. The fraud likelihood score can be represented as a numerical value within a defined range (e.g., 0 to 1, where 1 indicates the highest probability of fraud) or as a probabilistic confidence score. The validation system 106 can compare the computed fraud likelihood score to a predefined threshold to determine whether the request corresponds to an instance of fraud. The predefined threshold is a configurable parameter that can be adjusted based on the required sensitivity level and the tolerable rates of false positives and false negatives. If the fraud likelihood score exceeds the predefined threshold, the validation system 106 can classify the request as fraudulent and initiate a response, such as rejecting or blocking the request, flagging it for manual review, or generating an alert for further investigation. Responsive to the determination, the validation system 106 can generate a notification indicating that the request corresponds to an instance of fraud. Additionally, the magnitude by which the score exceeds the threshold can be used to determine the severity of the suspected fraud. For example, requests with scores marginally above the threshold can trigger additional verification checks, while high-confidence fraud classifications can result in immediate rejection.

The machine learning model 136 can be configured to evaluate the update request in a multidimensional feature space. The multidimensional feature space can be based on various attributes and contextual data points associated with the update request. The machine learning model 136 can process the feature vector to generate a fraud likelihood score. The machine learning model 136 can detect fraudulent patterns that may not be identifiable from individual data points in isolation. The machine learning model 136 can identify broader trends, such as a spike in verifications associated with a specific benefits provider.

Upon determining that the request is indicative of an instance of fraud, the validation system 106, based on the output of the machine learning model 136, can block the update request from being transmitted to the target database 114. The machine learning model 136 can generate instructions to cause the database server 110 to lock the target database 114 or a portion thereof to prevent the fraudulent update from being applied to the target database 114. For example, the validation system 106 can transmit a command, resulting from the analysis of the machine learning model 136, to the database server 110 to temporarily restrict write access to the relevant database 114 or table. The machine learning model 136 can generate instructions to cause the receiving system 102 to block or prevent further processing of the update request and notify the client system 108 of the blocked fraudulent activity. The validation system 106, responsive to the fraud assessment of the machine learning model 136, can generate a control signal to cause an external system, such as a security information and event management system, to log the suspicious activity. The machine learning model 136 can generate instructions to cause the validation system 106 to initiate automated security responses, including account suspension or multi-factor authentication enforcement for the associated user or device. The validation system 106, based on the instructions derived from the output of the machine learning model 136, can instruct the receiving system 102 or the data processing system 104 to perform any of the actions described herein, such as blocking the transmission, locking the database, rejecting the request, or triggering external security infrastructure.

The machine learning model 136 can be trained and configured to detect fraudulent activity related to benefits administration by evaluating multiple data sources and identifying suspicious patterns. The machine learning model 136 can evaluate audit trails and data from verification services to identify anomalies indicative of fraud. The machine learning model 136 can evaluate IP addresses associated with data update requests, logins, and other system interactions. The machine learning model 136 can flag logins from unusual or high-risk IP addresses, particularly those linked to known fraudulent activity, as suspicious. The machine learning model 136 can detect sudden changes in IP addresses, where access from multiple geographically distant locations within a short time frame can trigger alerts. The machine learning model 136 can be trained to evaluate patterns in API calls to verification services, such as identity verification and address validation. The machine learning model 136 can evaluate the frequency, timing, and distribution of these API calls to detect anomalies. For example, an unusually high number of identity verification requests for the same profile data structure within a short time frame can indicate an attempt to manipulate or falsify identity information, such as using synthetic identities or repeatedly modifying SSNs to bypass verification controls. The machine learning model 136 can also evaluate patterns in anomalous surges of verification-related activities, such as modifications to personal information, beneficiary updates, or direct deposit changes. A sudden spike in these activities, particularly occurring outside normal business hours or concentrated around specific profiles, can indicate potential coordinated fraudulent behavior.

The machine learning model 136 can be trained to process extracted features and identify benefits that exhibit a high susceptibility to fraudulent activity. In this regard, the machine learning model 136 can evaluate historical fraud data to detect recurring patterns and risk factors associated with frequently targeted benefits. For example, monetary claims with unusually large disbursements or claims exhibiting atypical frequency can correspond to a higher fraud risk. Similarly, benefits involving immediate payouts or lacking verifiable supporting documentation can be classified as high-risk. The susceptibility of benefits to fraud can be evaluated in a multidimensional feature space, incorporating attributes such as benefit classification, historical fraud incident rates, transaction amounts, document completeness metrics, and verification failure rates, among others. The machine learning model 136 can dynamically update the fraud risk score associated with different benefits by incorporating real-time transaction data, anomaly detection outputs, and evolving fraud trends.

The machine learning model 136 can be trained to detect microfraud, which refers to seemingly minor fraudulent activities with an individual impact below a predetermined threshold that often serve as precursors to larger, more complex fraud schemes. For example, a seemingly minor unauthorized change to a single digit in a beneficiary's phone number or SSN, while not immediately causing financial harm, can be a precursor to a later attempt to redirect funds or gain unauthorized access using that modified contact information. The machine learning model 136 can be configured to identify low-impact anomalies that, while individually minor, can collectively indicate coordinated fraudulent behavior patterns. For example, unauthorized or inconsistent modifications to SSNs can signal identity theft or synthetic identity fraud. The model can track SSN changes and flag discrepancies that deviate from an individual's historical data or conflict with other identity attributes. Similarly, manipulating benefit disbursements and illicitly redirecting funds can occur through the addition of new beneficiaries without sufficient verification. The machine learning model 136 can be trained to detect such beneficiary additions that lack supporting documentation, exhibit unusual patterns (e.g., multiple beneficiaries added within a short period), or coincide with high-value claims.

The validation system 106 can include interface with, communicate with, or otherwise utilize an interface controller 138. The interface controller 138 within the validation system 106 can be similar to, and include any of the structure and functionality of, the interface controller 120 described in connection with the receiving system 102, the interface controller 128 described in connection with the data processing system 104, or the interface controller 142 described in connection with the client system 108. For example, the interface controller 138 within the validation system 106 can communicate with the receiving system 102, the data processing system 104, the client system 108, or the database server 110 via the network 112 using one or more communication interfaces to carry out the various operations described herein. The interface controller 138 can be compatible with particular content objects and can be compatible with particular content delivery systems corresponding to particular content objects, structures of data, types of data, or any combination thereof.

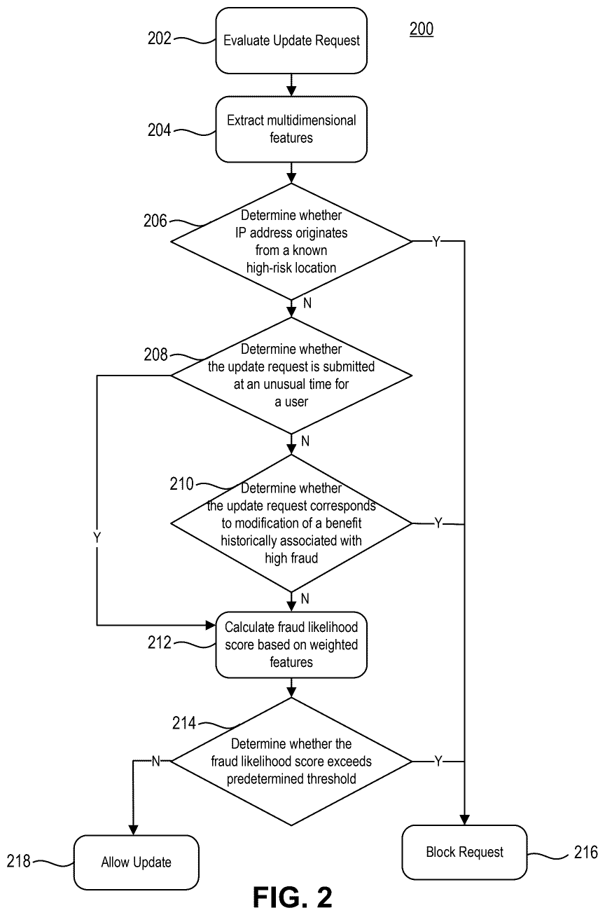

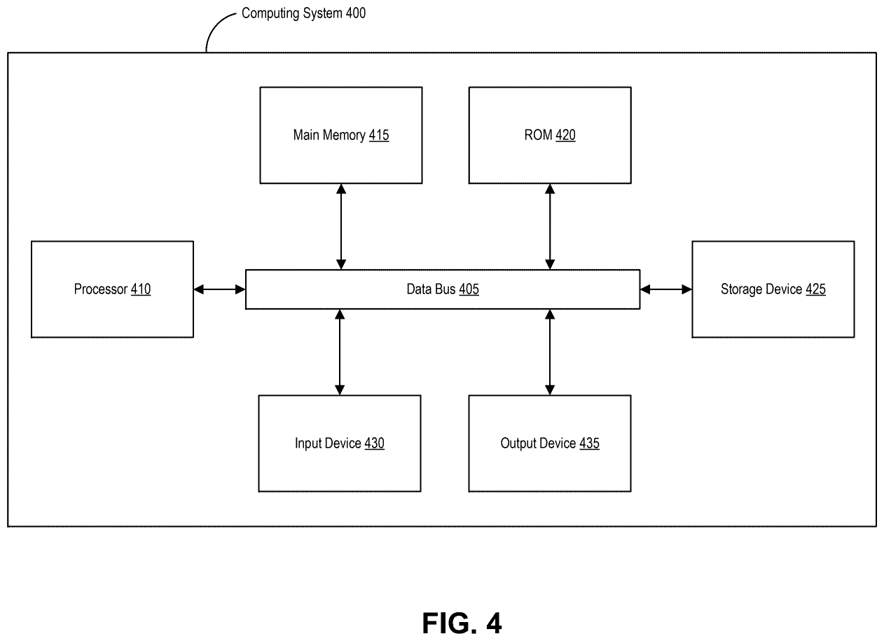

FIG. 2 depicts an example process 200 for providing secure network activity within a multidimensional node schema. The process 200 depicted in FIG. 2 can be performed by one or more component or function of system 100 depicted in FIG. 1 or FIG. 4. The process 200 can be performed by a server executing machine-readable software code, though it should be appreciated that the various operations can be performed by one or more computing devices or processors. The process 200 can include a series of operations based on various features associated with an incoming update request.

At operation 202, the server can evaluate the incoming update request to modify a data record. The server can validate the format and structure of the request, the user's authentication status, and the target data record, among others.

At operation 204, the server can extract a set of multidimensional features associated with the update request and the target data record. The multidimensional features can correspond to various aspects of the update request and associated data, such as user behavior patterns, contextual information, and the specific data being modified, among others. Examples of such features can include the originating IP address, the time of the request, the frequency of recent changes to the user's profile, the type of benefit being updated, and specific patterns within the data modification itself, among others.

At operation 206, the server can determine whether the IP address originates from a known high-risk location. For example, a machine learning model trained on data about malicious IP addresses or geographic regions with a high incidence of cybercrime can evaluate the originating IP address of the update request. If the IP address matches a known blacklist or is associated with suspicious activity, the server can raise a red flag. In such instances, the server can block the request, as the high-risk origin increases the likelihood of fraudulent intent. If the IP address is not associated with known risks, the server can proceed to operation 208 for further analysis.

At operation 208, the server can determine whether the update request is submitted at an unusual time for a user. For example, the server can maintain or have access to historical data about a user's activity patterns, including the times they usually log in and initiate update requests. A request submitted outside of such normal hours, especially during known off-peak times or unusual hours of the night, can be an indicator of unauthorized access or a compromised account. If the unusual timing increases the suspicion level, the server can proceed to operation 212 for the calculation of the overall fraud likelihood score. If the timing is considered normal, the server can proceed to operation 210.

At operation 210, the server can determine whether the update request corresponds to modification of a benefit historically associated with high fraud. The machine learning model trained on historical fraud data can identify specific benefits or data fields that are frequently targeted in fraudulent schemes. For example, changes to direct deposit information or beneficiary designations in certain types of policies can correlate strongly with prior fraud incidents. If modification of such a high-risk benefit increases the suspicion level, the server can block the request. If the benefit being modified does not match any historically high-risk fraud pattern, the server can proceed to 212 for the calculation of the overall fraud likelihood score.

At operation 212, the server can calculate a fraud likelihood score based on weighted features. For example, the machine learning model can aggregate the outputs gathered from the preceding evaluations. Each evaluated feature (e.g., IP address risk, unusual timing, benefit modification type, and other extracted features) can be assigned a weight specifying its predictive strength, as determined during model training. The machine learning model can combine the weighted features to generate a numerical score indicating the overall likelihood that the update request is fraudulent.

At operation 214, the server can determine whether the fraud likelihood score exceeds a predetermined threshold. The server can compare the calculated fraud likelihood score to a predefined threshold. The threshold can be a configurable value that balances the need to detect fraud effectively with the risk of generating false positives (e.g., incorrectly flagging legitimate requests as fraudulent). The threshold can be adjusted based on the sensitivity requirements of the system and the acceptable level of disruption to legitimate users.

If the fraud likelihood score exceeds the threshold, the server can block the update request at operation 216. For example, the server can prevent the potentially fraudulent modification from being applied to the target database. The server can also generate an alert or notification for further investigation.

If the fraud likelihood score does not exceed the threshold, the server can allow the update request to proceed at operation 218. For example, the server can allow the update request to be transmitted to the target database for processing and application of the update.

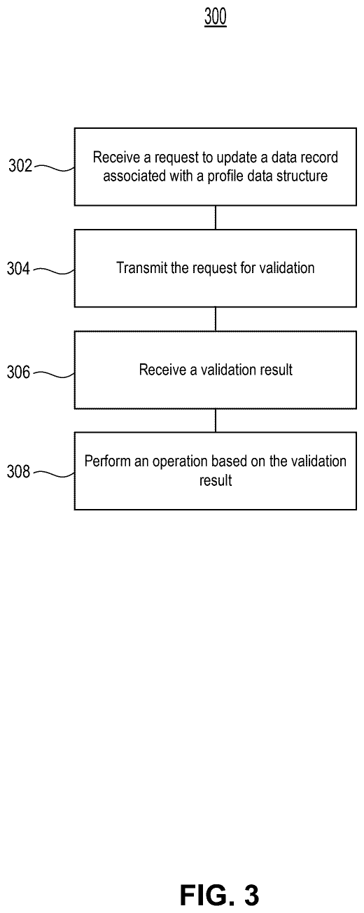

FIG. 3 depicts a method 300 of providing secure network activity in a distributed computing environment, including with regard to managing data updates within the distributed computing environment. The method 300 can be implemented using one or more systems or components depicted in FIG. 1 or FIG. 4, including, for example, data processing system 104 or computing system 400. The method 300 can include operations 302-308. The operations 302-308 can be executed in any order or sequence.

At 302, the method 300 can include receiving a request to update a data record associated with a profile data structure. For example, the method can include a first system receiving the request to update the data record associated with the profile data structure. The first system can correspond to a receiving system, such as a request processing system, a web server, an application programming interface (API) gateway, a message queue system, or any other system configured to receive and process incoming requests. The first system can be a standalone system or a component within a computing infrastructure. The first system can correspond to an administrative system, such as a payroll system, a human resources (HR) system, a talent management system, a time and benefits administration system, or any other system that manages employee data and processes related requests. For example, a request to update a beneficiary designation can originate from an HR system, a change of address can be initiated through a self-service portal connected to a time and benefits administration system, or a change in salary can be initiated by the payroll system. The method can include the first system receiving the request to update the data record associated with the profile data structure in response to an event. The event can include at least one of a data modification event within the plurality of databases, a data generation event within the plurality of databases, a data synchronization event between databases and an external system, or a scheduled data processing event.

The request can include one or more identification parameters to identify the data record to be updated. The identification parameters can include at least one of an identifier associated with the data record, a timestamp associated with the data record, a location associated with the data record, an entity type associated with the data record, or a transaction type associated with the data record. The method can include the first system filtering, based on the identification parameters and the profile data structure, a plurality of databases maintained in a computing environment to identify a target database storing the data record to be updated. Each database can store one or more data records associated with the profile data structure. Each data record can include a plurality of field-value pairs. The method can include the first system interacting with an application programming interface (API) to coordinate data exchange between the plurality of databases maintained in the computing environment. The method can include the first system maintaining a mapping data structure associating the one or more identification parameters and the profile data structure with locations of data records in the plurality of databases maintained in the computing environment. The method can include the first system querying the mapping data structure based on the one or more identification parameters to identify the target database storing the data record to be updated.

The method can include the first system selecting a subset of features from a set of features associated with the data record. The subset of features can be selected based on indications of fraud. The subset of features can include at least one of a frequency of data changes, a correlation of data with external sources, a pattern of data access, or a temporal characteristic of data. The method can include the first system selecting the subset of features based on predefined rules for fraud detection. The method can include the first system selecting the subset of features based on one or more machine learning models trained to identify features indicative of an instance of fraud. Additionally, the request can include one or more update parameters specifying the update to be applied to the identified data record. The update parameters can specify at least one of a modification of a value associated with a field within the data record, an addition of a new field to the data record, a deletion of an existing field from the data record, or a modification of a relationship across data records.

At 304, the method 300 can include transmitting the request for validation. The method can include the first system transmitting the request to a second system for validation. The second system can include any system or combination of systems configured to perform validation checks on data update requests. The second system can include, but is not limited to, a dedicated validation server, a rule-based engine, a machine learning-based fraud detection system, a combination of rule-based and machine learning systems, or a service provided by a third-party system. The second system can access various data sources, including databases, external APIs, and data feeds, to perform validation checks. The first system can perform validation checks, depending on the implementation. For example, the first system can use predefined rules, execute a local machine learning model, or query databases. A combination of the first system and the second system can perform validation checks. The method can include the second system receiving, from the first system, the request to update the data record associated with the profile data structure. Upon receiving the request, the method can include the second system extracting the subset of features from the set of features associated with the data record to be updated. The method can include the second system determining, via a machine learning model, based on the subset of features associated with the data record to be updated, that the request is indicative of an instance of fraud or a valid update request.

The method can include the second system training one or more machine learning models on a training dataset. The training dataset can include a plurality of data records and corresponding labels. The training dataset can include a set of features extracted from data records stored in the databases. The machine learning model can be configured to associate features extracted from each data record with a label indicating whether the data record is fraudulent or valid. Upon receiving the request, the method can include the second system executing the machine learning model to generate a fraud likelihood score for the request based on the subset of features extracted from the data record to be updated. The method can include the second system determining that the request corresponds to an instance of fraud based on the fraud likelihood score exceeding a predefined threshold.

At 306, the method 300 can include receiving a validation result. The method can include the first system receiving the validation result transmitted by the second system. The validation result can indicate the request is indicative of at least one of an instance of fraud or a valid update request.

At 308, the method 300 can include performing an operation based on the validation result. The method can include the first system generating, upon receiving the validation result indicating the valid update request, instructions to cause the target database to update the data record based on the update parameters. The method can include the first system generating a notification indicating the request corresponds to an instance of fraud. The method can include the first system generating instructions, upon determining that the request is indicative of the instance of fraud, to block the update request from being transmitted to the target database.

FIG. 4 depicts a block diagram of a computing system 400 for implementing the embodiments of the technical solutions discussed herein, in accordance with various aspects. FIG. 4 illustrates a block diagram of an example computing system 400, which can also be referred to as the computer system 400. Computing system 400 can be used to implement elements of the systems and methods described and illustrated herein. Computing system 400 can be included in and run any device (e.g., a server, a computer, a cloud computing environment, or a data processing system).

Computing system 400 can include at least one bus data bus 405 or other communication device, structure, or component for communicating information or data. Computing system 400 can include at least one processor 410 or processing circuit coupled to the data bus 405 for executing instructions or processing data or information. Computing system 400 can include one or more processors 410 or processing circuits coupled to the data bus 405 for exchanging or processing data or information along with other computing systems 400. Computing system 400 can include one or more main memories 415, such as a random access memory (RAM), dynamic RAM (DRAM), cache memory or other dynamic storage device, which can be coupled to the data bus 405 for storing information, data and instructions to be executed by the processor(s) 410. Main memory 415 can be used for storing information (e.g., data, computer code, commands, or instructions) during execution of instructions by the processor(s) 410.

Computing system 400 can include one or more read only memories (ROMs) 420 or other static storage device 425 coupled to the bus 405 for storing static information and instructions for the processor(s) 410. Storage devices 425 can include any storage device, such as a solid-state device, magnetic disk, or optical disk, which can be coupled to the data bus 405 to persistently store information and instructions.

Computing system 400 can be coupled via the data bus 405 to one or more output devices 435, such as speakers or displays (e.g., liquid crystal display or active matrix display) for displaying or providing information to a user. Input devices 430, such as keyboards, touch screens or voice interfaces, can be coupled to the data bus 405 for communicating information and commands to the processor(s) 410. Input device 430 can include, for example, a touch screen display (e.g., output device 435). Input device 430 can include a cursor control, such as a mouse, a trackball, or cursor direction keys, for communicating direction information and command selections to the processor(s) 410 for controlling cursor movement on a display.

The processes, systems and methods described herein can be implemented by the computing system 400 in response to the processor 410 executing an arrangement of instructions contained in main memory 415. Such instructions can be read into main memory 415 from another computer-readable medium, such as the storage device 425. Execution of the arrangement of instructions contained in main memory 415 causes the computing system 400 to perform the illustrative processes described herein. One or more processors 410 in a multi-processing arrangement can also be employed to execute the instructions contained in main memory 415. Hard-wired circuitry can be used in place of or in combination with software instructions together with the systems and methods described herein. Systems and methods described herein are not limited to any specific combination of hardware circuitry and software.

Although an example computing system has been described in FIG. 4, the subject matter, including the operations described in this specification, can be implemented in other types of digital electronic circuitry, or in computer software, firmware, or hardware, including the structures disclosed in this specification and their structural equivalents, or in combinations of one or more of them.

The foregoing examples have been provided merely for the purpose of explanation and are in no way to be construed as limiting of the present disclosure. While aspects of the present disclosure have been described with reference to an exemplary embodiment, it is understood that the words which have been used herein are words of description and illustration, rather than words of limitation. Changes can be made, within the purview of the appended claims, as presently stated and as amended, without departing from the scope and spirit of the present disclosure in its aspects. Although aspects of the present disclosure have been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device,” “component” or “data processing apparatus” or the like encompass various apparatuses, devices, and machines for processing data, including, by way of example, a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media, and memory devices, including, by way of example, semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements, and features discussed in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

References to “or” can be construed as inclusive so that any terms described using “or” can indicate any of a single, more than one, and all of the described terms. References to at least one of a conjunctive list of terms can be construed as an inclusive OR to indicate any of a single, more than one, and all of the described terms. For example, a reference to “at least one of ‘A’ and ‘B” can include only 'A,’ only ‘B,’ as well as both ‘A’ and ‘B.’ Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as substitutions, changes and omissions can be made in the design, operating conditions and arrangement of the disclosed elements and operations without departing from the scope of the present disclosure.

1. A system, comprising:
one or more processors, coupled with memory, to:
receive an indication of a request to update a data record associated with a profile data structure, the request including:
one or more identification parameters to identify the data record to be updated; and
one or more update parameters specifying the update to be applied to the data record;
filter, based on the one or more identification parameters and the profile data structure, a plurality of databases maintained in a computing environment by querying a mapping data structure that associates the one or more identification parameters and the profile data structure with locations of data records in the plurality of databases, to identify a target database storing the data record to be updated;
select, responsive to the filtering, a subset of features indicative of fraud and associated with the data record stored in the target database;
determine, by inputting the subset of features associated with the data record into a machine learning model trained on labeled data records having labels indicating fraudulent or valid update requests, a score indicating a likelihood that the request is fraudulent;
determine, based on a comparison of the score with a threshold, that the request is indicative of at least one of:
i) an instance of fraud; or
ii) a valid update request; and
generate, upon determining that the request is indicative of the valid update request, instructions to cause the target database to update the data record based on the one or more update parameters.

2. The system of claim 1, wherein the one or more processors further:
receive the indication of the request to update the data record associated with the profile data structure in response to an event.

3. The system of claim 2, wherein the event comprises at least one of a data modification event within the plurality of databases, a data generation event within the plurality of databases, a data synchronization event between the plurality of databases and an external system, or a scheduled data processing event.

4. The system of claim 1, wherein the one or more identification parameters comprise at least one of an identifier associated with the data record, a timestamp associated with the data record, a location associated with the data record, an entity type associated with the data record, or a transaction type associated with the data record.

5. The system of claim 1, wherein the one or more update parameters specify at least one of a modification of a value associated with a field within the data record, an addition of a new field to the data record, a deletion of an existing field from the data record, or a modification of a relationship between the data record and a second data record.

6. The system of claim 1, wherein the one or more processors further:
maintain the mapping data structure associating the one or more identification parameters and the profile data structure with the locations of data records in the plurality of databases maintained in the computing environment.

7. The system of claim 1, wherein each database of the plurality of databases stores one or more data records associated with the profile data structure, each data record comprising a plurality of field-value pairs.

8. The system of claim 1, wherein the one or more processors further:
interact with an application programming interface (API) to coordinate data exchange between the plurality of databases maintained in the computing environment.

9. The system of claim 1, wherein the one or more processors further:
train the machine learning model on a training dataset comprising a plurality of data records and corresponding labels, wherein the machine learning model learns to associate features extracted from each data record with a label indicating whether the data record is fraudulent or valid.

10. The system of claim 1, wherein upon receipt of a second request to update a second data record, the one or more processors further:
determine, by inputting a second subset of features associated with the second data record into the machine learning model, a second score that indicates a likelihood that the second request is fraudulent;
determine, based on a comparison of the second score with the threshold, that the second request corresponds to the instance of fraud; and
generate, responsive to the determination, a notification indicating the second request corresponds to the instance of fraud.

11. The system of claim 1, wherein the one or more processors further:
generate instructions, upon determining that the request is indicative of the instance of fraud, to block the update request from being transmitted to the target database.

12. The system of claim 1, wherein the one or more processors further:
select the subset of features based on at least one of:
predefined rules for fraud detection; or
one or more machine learning models trained to identify features indicative of the instance of fraud.

13. A method, comprising:
receiving, by a first system, a request to update a data record associated with a profile data structure, the request including:
one or more identification parameters to identify the data record to be updated; and
one or more update parameters specifying the update to be applied to the data record;
filtering, by the first system, based on the one or more identification parameters and the profile data structure, a plurality of databases maintained in a computing environment by querying a mapping data structure that associates the one or more identification parameters and the profile data structure with locations of data records in the plurality of databases, to identify a target database storing the data record to be updated;
selecting, by the first system, responsive to the filtering, a subset of features indicative of fraud and associated with the data record stored in the target database identified by the filtering:
transmitting, by the first system, the request to a second system for validation;
receiving, by the first system, a validation result from the second system, the validation result based on inputting the subset of features associated with the data record into a machine learning model trained on labeled data records having labels indicating fraudulent or valid update requests, and indicating, based on a comparison of a score with a threshold, that the request is indicative of at least one of:
i) an instance of fraud; or
ii) a valid update request; and
generating, by the first system, upon receiving the validation result indicating the valid update request, instructions to cause the target database to update the data record based on the one or more update parameters.

14. The method of claim 13, further comprising:
receiving, by the first system, the request to update the data record associated with the profile data structure in response to an event.

15. The method of claim 14, wherein the event comprises at least one of a data modification event within the plurality of databases, a data generation event within the plurality of databases, a data synchronization event between the plurality of databases and an external system, or a scheduled data processing event.

16. The method of claim 13, wherein the one or more identification parameters comprise at least one of an identifier associated with the data record, a timestamp associated with the data record, a location associated with the data record, an entity type associated with the data record, or a transaction type associated with the data record.

17. The method of claim 13, wherein the one or more update parameters specify at least one of a modification of a value associated with a field within the data record, an addition of a new field to the data record, a deletion of an existing field from the data record, or a modification of a relationship between the data record and a second data record.

18. The method of claim 13, further comprising:
maintaining, by the first system, the mapping data structure associating the one or more identification parameters and the profile data structure with the locations of data records in the plurality of databases maintained in the computing environment.

19. The method of claim 13, wherein each database of the plurality of databases stores one or more data records associated with the profile data structure, each data record comprising a plurality of field-value pairs.

20. A non-transitory computer readable medium including one or more instructions stored thereon and executable by a processor to:
receive, from a first system, a request to update a data record associated with a profile data structure, the request including:
one or more identification parameters to identify the data record to be updated; and
one or more update parameters specifying the update to be applied to the data record;
filter, based on the one or more identification parameters and the profile data structure, a plurality of databases maintained in a computing environment by querying a mapping data structure that associates the one or more identification parameters and the profile data structure with locations of data records in the plurality of databases, to identify a target database storing the data record to be updated;
select, responsive to the filtering, a subset of features indicative of fraud and associated with the data record stored in the target database identified by the filtering;
determine, by inputting the subset of features associated with the data record into a machine learning model trained on labeled data records having labels indicating fraudulent or valid update requests, a score indicating a likelihood that the request is fraudulent;
determine, based on a comparison of the score with a threshold, that the request is indicative of at least one of:
i) an instance of fraud; or
ii) a valid update request; and
transmit a validation result to the first system, the validation result indicating the request is indicative of the instance of fraud or the valid update request.
